(19) United States
(12) Patent Application Publication
(10) Pub. No.: US 2020/0289999 A1
(43) Pub. Date: Sep. 17, 2020

(54) Well Material Distribution Systems and Methods

(71) Applicant: Blake Whitlatch, Mandeville, LA (US)

(72) Inventor: Blake Whitlatch, Mandeville, LA (US)

(21) Appl. No.: 16/298,258

(22) Filed: Mar. 11, 2019

(51) Int. Cl. B01F 15/02; B65B 69/00

(52) U.S. Cl. CPC B01F 15/0206; B01F 2215/0081; B65B 69/0008; B01F 15/0251

(57) ABSTRACT

A well material distribution method includes obtaining at least one material-containing sack containing at least one well material, placing the at least one material-containing sack in an automatic sack cutting machine, opening the at least one material-containing sack and dispensing the at least one well material by operation of the automatic sack cutting machine and distributing the at least one well material from the automatic sack cutting machine directly into a mixing vessel configured to simultaneously handle a plurality of well materials. Well material distribution systems are also disclosed.

### FIELD

Illustrative embodiments of the disclosure generally relate to hydrocarbon (oil and gas) well drilling applications. More particularly, illustrative embodiments of the disclosure relate to well material distribution systems and methods suitable for distributing well materials from an automatic sack cutting machine (ASCM) which opens and empties the contents of a material-containing sack directly into a mixing vessel which handles multiple well materials or components such as drilling fluids, cement and cement spacers and completion brine as well as filtering and handling cuttings for zero-discharqe applications, for example and without limitation, without cross-contamirmtion for enhanced efficiency in hydrocarbon well drilling and other applications.

### BACKGROUND

The background description provided herein is solely for the purpose of generally presenting the context of the illustrative embodiments of the disclosure. Aspects of the background description are neither expressly nor impliedly admitted as prior art against the claimed subject matter.

A typical hydrocarbon well-drilling and completion project may involve multiple mixing operations that require various mixing procedures designed solely for each operation. Current protocols for the mixing operations tnav require that a single service providerspecific manage each mixing operation. Each mixing operation uses its own mixing vessel and other equipment to facilitate the operation. As an example, drilling fluids may be mixed using mixing equipment which is permanently fixed to the rig. Cement may be mixed by a cement company using its own mixing equipment. The cement spacer may be mixed using the mud pit system on the drilling rig. Completion brine may also be mixed using the mud pit system on the drilling rig, with a separate service provioer used for the filtration equipment. Handling equipment for drilled cuttings may be provided by another service provider to manage drilled cuttings when zero-discharge is necessary or required by law.

There is no single service provider that manages all of the mixing operations or provides a single mixing apparatus that can manage all the various mixing operations of a hydrocarbon well drilling and completion project. By providing a single, versatile, portable mixing apparatus on a drilling rig that can perform mixing of all of the compounds used in the project, the drilling process can be streamlined and rendered more efficient.

In some applications, it may be desirable to use an Automatic Sack Cutting Machine (ASCM) which cuts and empties sacks containing well materials that may be used in the formation of drilling mud, cement and other fluids or components before, during and/or after well drilling or hydrocarbon production. An ASCM may eliminate exposure of operating personnel to chemicals and dust from the well materials. The well materials are typically transported by auger from the ASCM to one or more intermediary holding vessels such as a jet hopper. From the jet hopper, the well materials may be transported to a mixing device or other destination for formation of the drilling mud, cement and/or other components. The transport distance from the ASCM to the jet hopper may range typically from 10 to 50 feet. The auger used to transport the well matenals may frequently become caked with material and require regular unplugging and cleaning. The unplugging process may require significant downtime during critical well operations, preventing use of the ASCM during that time. Moreover, the caked well material may be cross-contaminated with other material introduced into the jet hopper through the same auger. In some applications, the well materials may be transported from the ASCM to the jet hopper along an inclined material transfer path.

Well material distribution systems and methods suitable for distributing well materials from an automatic sack cutting machine (ASCM) which opens and empties the contents of a material-containing sack directly into a mixing vessel which handles multiple well materials or components such as drilling fluids, cement and cement spacers and completion brine as well as filtering and handling cuttings for zero-discharge applications, for example and without limitation, without cross-contamination for enhanced efficiency in hydrocarbon well drilling and other applications may be desirable in some hydrocarbon well drilling and other applications.

### SUMMARY

Illustrative embodiments of the disclosure are generally directed to well material distribution methods suitable for distributing well materials from an automatic sack cutting machine (ASCM) directly into a mixing vessel which handles multiple well materials or components. An illustrative embodiment of the well material distribution methods may include obtaining at least one material-containing sack containing at least one well material; placing the at least one material-containing sack in an automatic sack cutting machine; opening the at least one material-containing sack and dispensing the at least one well material by operation of the automatic sack cutting machine; and distributing the at least one well material from the automatic sack cutting machine directly into a mixing vessel configured to simultaneously handle a plurality of well materials.

Illustrative embodiments of the disclosure are further generally directed to well material distribution systems suitable for distributing well materials from a material-containing sack directly into a mixing vessel which handles multiple well materials or components. An illustrative embodiment of the well material distribution systems may include an automatic sack cutting machine (ASCM) configured to open at least one material-containing sack and dispense at least one well material from the at least one material-containine sack. At least one mixing vessel may be disposed in direct communication with the automatic sack cutting machine. The at least one mixing vessel may be configured to simultaneously handle a plurality of well materials and receive the at least one well material directly from the automatic sack cutting machine.

### BRIEF DESCRIPTION OF THE DRAWINGS

Illustrative embodiments of the disclosure will now be described, by way of example, with reference to the accompanying drawings, in which:

FIG. 1 is a perspective view of an illustrative embodiment of the well material distribution systems provided on a rig platform and connected to a mixing vessel in typical application of the system;

FIG. 2 is a front view of a typical mixing vessel with the illustrative well material distribution system of FIG. 1 connected to the mixing vessel through a material transfer conduit;

FIG. 3 is a functional block diagram of the illustrative well material distribution system and other components communicating with the mixing vessel;

FIG. 4 is a front view of a typical mixing vessel in implementation of the well material distribution systems with various conduits and functional components connected to the mixing vessel in typical implementation of the mixing vessel;

FIG. 5 is a functional block diagram illustrating a typical configuration of the well material distribution systems;

FIG. 6 is a flanctional block diagram illustrating a typical alternative configuration of the well material distribution systems;

FIG. 7 Is a functional block diagram illustrating another typical alternative configuration of the well material distribution systems;

FIGS. 8-12 are block diagrams illustrating typical sequential operation of the well material distribution systems; and

FIG. 13 is a flow diagram of an illustrative embodiment of the well material distribution methods.

### DETAILED DESCRIPTION

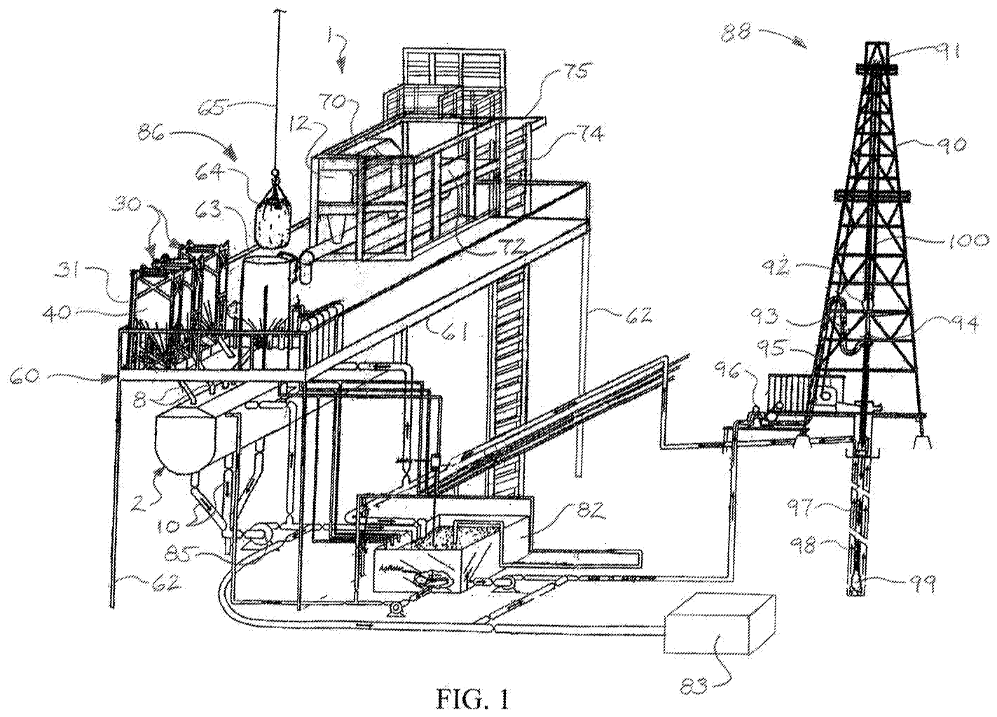

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound bye any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed hevein are not to be considered as limiting, unless the claims expressly state otherwise.

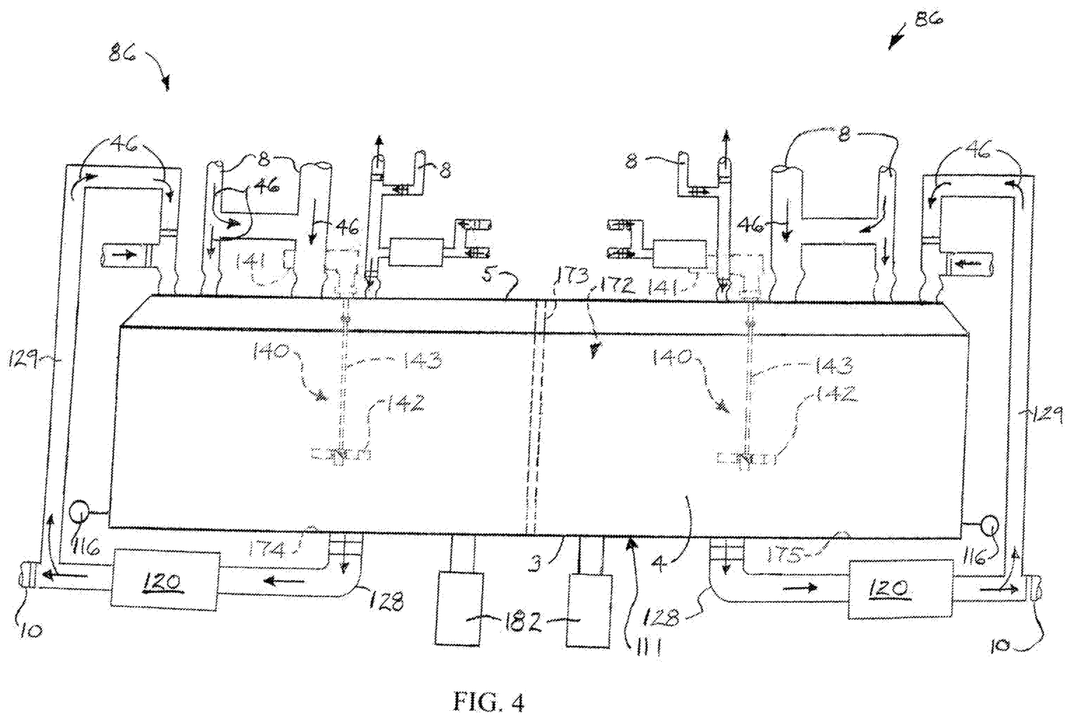

Referring Initially to FIGS. 1-4 of the drawings, an illustrative embodiment of the well material distribution systems, hereinafter system, is generally indicated by reference numeral 1. As will be hereinafter described, the system 1 may be suitable for distributing well materials 46 (FIG. 4) from an automatic sack cutting machine (ASCM) 12 directly into a mixing vessel 2 which typically handles multiple well materials or components 46 such as drilling fluids, cement and cement spacers and completion brine as well as filtering and handling cuttings for zero-discharge applications, for example and without limitation. As used herein, “direct”, “directly” and like terminology denotes transfer of well materials 46 from the ASCM 12 to the mixing vessel 2 without being first transferred through one or more intermediary holding vessels such as a jet hopper, for example and without limitation. The system 1 may facilitate introduction of well materials 46 from a material-containing sack 44 (FIGS. 8-12) into the mixing vessel 2 without cross-contamination for enhanced efficiency in hydrocarbon well drilling and other applications. As used herein, “well materials” include but are not limited to solid particles, powders, dust, liquids or combinations thereof which may be used in the formulation of active mud, drilling mud, cement and/or other solids or liquids used in the drilling, production, maintenance, remediation andfor other operations of a hydrocarbon well 88 (FIG. 1).

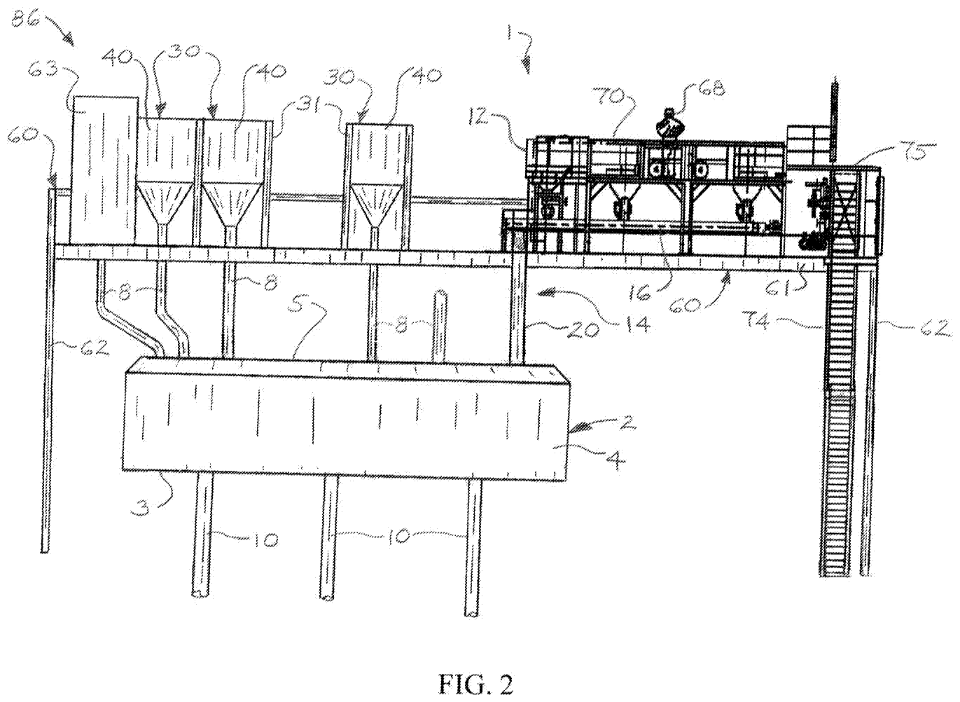

As illustrated in FIGS. 1 and 2 and will be hereinafter described, in some applications, the system 1 may be deployed on a rig platform 60 which provides support for the various mixing operations required in the drilling production and/or other operations of the hydrocarbon well 88. The hydrocarbon well 88 may be an onshore well, as illustrated, or may alternatively be an offshore well. As illustrated in FIG. 1, the onshore hydrocarbon well 88 may include a hydrocarbon well rig 90 having a block and tackle 100 with a crown block 91 and a traveling block 92. A drill string 98 may be supported by the block and tackle 100. The drill string 98 may drivingly engage a drill bit 99 for rotation in formation of a subterranean wellbore beneath the hydrocarbon well rig 90. A typically cement casing 97 may encase the subterranean wellbore beneath the hydrocarbon well rig 90.

Draw works 95 may facilitate selective raising and lowering of the drill string 98 via the block and tackle 100. A mud hose 93 may be coupled to the drill string 98 typically via a swivel 94. A mud pump 96 may be coupled to the mud hose 93.

The rig platform 60 may have a conventional design with an elevated rig deck 61 which is supported by multiple rig legs 62. The rig legs 62 may be anchored in the ground (not illustrated) in the case of onshore operations, or alternatively, may be anchored in an ocean floor (not illustrated) in the case of offshore operations.

At least one mixing vessel 2 may be disposed beneath the rig deck 61 of the rig platform 60. The mixing vessel 2 may have any suitable support structure which is suitable for the purpose. In some embodiments, the mixing vessel 2 may be the same as or similar in design to the mixing vessel described in U.S. application Ser. No. 15/885,997, filed Feb. 1, 2018 and entitled MIXING APPARARTUS, which application is hereby incorporated by reference herein in its entirety. Accordingly, the mixing vessel 2 may have a generally elongated, oblong or ob-round shape. As illustrated in FIGS. 2 and 4, the mixing vessel 2 may have a mixing vessel bottom 3. A generally elongated, oblong or ob-round mixing vessel wall 4 may extend upwardly from the mixing vessel bottom 3. As illustrated in FIG. 4, the mixing vessel bottom 3 and mixing vessel wall 4 may form a mixing vessel interior 172. At least one mixing vessel partition 173 may divide the mixing vessel interior 172 into at least a first mixing compartment 174 and a second mixing compartment 175. In some non-limiting embodiments, two or more mixing vessel partitions 173 may divide the mixing vessel interior 172 into three or more mixing compartments.

A mixing vessel lid 5 may be supported by the mixing vessel wall 4. The mixing vessel lid 5 may provide for sealing of the mixing vessel interior and dust-free dumping of dry products into the mixing vessel interior in typical use of the mixing vessel 2. The mixing vessel lid 5 may be fitted with one or more viewing windows (not illustrated) which enable an operator of the mixing vessel 2 to view the contents of the mixing vessel interior during mixing. The mixing vessel lid 5 may be selectively detachable and removable from the mixing vessel wall 4 to facilitate access to the mixing vessel interior 172 for the purpose of repairing, maintaining and/or replacing paddle agitators 142 (FIG. 4) and/or other various functional components of a mixing device 140 in the mixing vessel interior 172. The mixing vessel bottom 3, the mixing vessel wall 4, the mixing vessel partition 173, the mixing vessel lid 5 and other structural components of the mixing vessel 2 may be fabricated of any material or combination of materials which renders the mixing vessel 2 suitable for its purpose. In some non-lintiting embodiments, the structural components of the mixing vessel 2 may be fabricated of abrasion-resistant materials. For example and without limitation, in some non-limiting embodiments, the various structural components of the mixing vessel 2 may be fabricated of abrasion-resistant steel. In some applications, the mixing vessel 2 may utilize radioactive source technology to weigh the contents to be mixed in the mixing vessel 2.

At least one pump, supply and distribution system 86 may fluidly interface with the mixing vessel 2. As illustrated in FIGS. 1 and 2, the pump, supply and distribution system 86 may include at least one hopper 63 which may contain a supply of dry product or solid bulk material (not illustrated) such as drilling material, for example and without limitation. At least one vessel inlet conduit 8 may be disposed in communication with the hopper 63. A discharge end (not illustrated) of the vessel inlet conduit 8 may be disposed in communication with the mixing vessel interior of the mixing vessel 2 typically through the mixing vessel wall 4 or mixing vessel lid 5. Accordingly, in typical operation of the mixing apparatus 2, a selected weight or quantity of the dry product may be dispensed from the hopper 63, through the vessel inlet conduit 8 and into the mixing vessel interior 172 for mixing. The dry product may be loaded in the selected weight or quantity into the hopper 63 from a large bag 64 (FIG. 1) which may be supported by a suitable lifting assembly 65. In other non-limiting embodiments, the dry product may be pumped into the mixing vessel interior 172 of the mixing vessel 2 from a remote container (not illustrated) using any suitable dry product pump and supply mechanism. As illustrated in FIG. 4, in some embodiments, each of the first mixing compartment 174 and the second mixing compartment 175 in the mixing vessel 2 may be fitted with a corresponding pump, supply and distribution system 86 which contains, pumps and distributes the components to be mixed into each of the first mixing compartment 174 and the second mixing compartment 175.

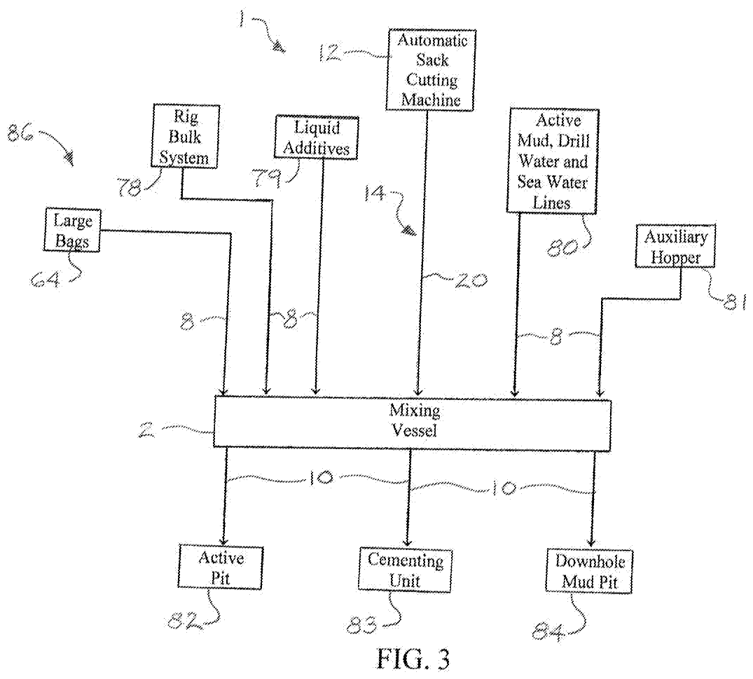

As further illustrated in FIG. 3, in some non-limiting embodiments, the pump, supply and distribution system 86 may further include at least one vessel inlet conduit 8 for an existing drilling rig bulk system 78 through which a material such as barite, gel or cement, for example and without limitation, may be added to the mixing vessel interior. Other vessel inlet conduits 8 may include at least one liquid product additive line to facilitate addition of any liquid additive or combination of liquid additives 79 and/or other product to the mixing vessel 2; active mud, drill water and sea water lines 80 for delivering drilling mud to the mixing vessel 2; and/or at least one output flow line to deliver the slurry product to its destination elsewhere on the rig platform 60. At least one auxiliary hopper 81 may be connected to the mixing vessel 2 through a vessel inlet conduit 8 to facilitate addition of other products to the mixing vessel 2.

As further illustrated in FIGS. 1 and 2, in some non-limiting embodiments, the pump, supply and distribution system 86 may include at least one silo assembly 30 for containing dry products which may be used in the drilling of hydrocarbon wells, for example and without limitation. Each silo assembly 30 may include at least one structural frame 31. At least one silo vessel 40 may be supported by the structural frame 31. In some non-limiting embodiments, the silo vessel 40 may be hollow and may be constructed of welded sheets of thin steel or the like. In some embodiments, the details of the structure and use of each silo assembly 30 may be as is described in U.S. Pat. No. 5,303,998, which is hereby incorporated by reference herein in its entirety. At least one silo vessel 40 of the silo assembly 30 may be disposed in fluid communication with the mixing vessel 2 typically through a corresponding vessel inlet conduit 8, for example and without limitation. The silo assembly 30 may include the input for the large bags 64, the bulk rig system 78, the liquid additives 79, the active mud lines 80 and/or the auxiliary hopper 81.

In some applications, various components may be connected to the mixing vessel 2 through vessel outlet conduits 10. As illustrated in FIG. 3, these components may include, tbr example and without limitation, at least one active pit 82 and/or at least one downhole mud pit 84 which may provide drilling mud or fluid to the drill string 98 for the drilling operation. At least one cementing unit 83 may be connected to the mixing vessel 2 for the installation of casing 97, centralizers and the like in the hydrocarbon well 88. As illustrated in FIG. 1, at least one mixer discharge pump 85 may be connected to the vessel outlet conduits 10. The mixer discharge pump 85 may pump active mud from the mixing vessel 2 to the active pit 82 and/or the downhole mud pit 84 (FIG. 3). A mud pump 96 may pump the active mud from the active put 82 through the drill string 98 and from the drill hit 99 for drilling and/or other purposes.

As further illustrated in FIG. 4, at least one mixing device 140 may be disposed in each corresponding first mixing compartment 174 and second mixing compartment 175 of the mixing vessel 2. In some embodiments, each mixing device 140 may be a gear-driven vertical mixer including an electric motor 141. The electric motor 141 may be mounted on the mixing vessel lid 5 of the mixing vessel 2 using brackets, mechanical fasteners and/or other suitable attachment technique. An agitator drive shaft 143 may be drivingly engaged by the electric motor 141. The agitator drive shall 143 may extend vertically from the electric motor 141 through a shall opening (not illustrated) in the mixing vessel lid 5 into the mixing vessel interior 172. Paddle agitators 142 may extend from the agitator drive shaft 143. Accordingly, responsive to operation of the electric motor 141, the agitator drive shaft 143 may rotate the paddle agitators 142 in the corresponding first mixing compartment 174 or second mixing compartment 175 to mix the contents of each.

The first mixing compartment 174 and the second mixing compartment 175 in the mixing vessel interior 172 of the mixing vessel 2 may have the same or different volumes. In some non-limiting embodiments, the mixing vessel interior 172 may have a volume of about 160 barrels, and the first mixing compartment 174 and the second mixing compartment 175 may each have a volume of about 80 barrels. In other non-limiting embodiments, the volume of the vessel interior 172 may be larger or smaller than 160 barrels, and each of the first mixing compartment 174 and the second mixing compartment 175 may have a volume which is larger or smaller than 80 barrels. Each of the first mixing compartment 174 and the second mixing compartment 175 may be fitted with the abrasive-resistant paddle agitators 142 (FIG. 4) to provide a complete clean-out to each of the first mixing compartment 174 and the second mixing compartment 175 after mixing. The abrasive-resistant paddle agitators 142 may have a conventional design which is known by those skilled in the art. In some non-limiting embodiments, heavy-duty stuffing boxes (not illustrated) may be provided to the mixing vessel 2 for the purpose of preventing material from contaminating the main bearings of the abrasive resistant paddle agitators 142, as is known by those skilled in the art.

As further illustrated in FIG. 4, in some non-limiting embodiments, the mixing vessel 11 may utilize radioactive source technology to weigh the contents to be mixed in the respective first mixing compartment 174 and second mixing compartment 175 of the mixing vessel 2. A mechanical scale 116 may be provided at each end of or in an other suitable location on the mixing vessel wall 4 for fine weight measurement of the contents of the corresponding first mixing compartment 174 and second mixing compartment 175. In some non-limiting embodiments, each mechanical scale 116 may be configured to read an accurate tenth of a percent to two pounds per ton of the contents in the corresponding first mixing compartment 174 and second mixing compartment 175.

In some embodiments, at least one discharge line 128 may be disposed in fluid communication with each of the first mixing compartment 174 and the second mixing compartment 174 of the mixing vessel 2, typically through the mixing vessel bottom 3 of the mixing vessel 2. A transfer pump 120 may be provided in the discharge line 128. The transfer pump 120 may include an intake side that communicates with the discharge line 128 and a discharge side that communicates with a vessel outlet conduit 10. In some non-limiting embodiments, a vessel return conduit 129 may be disposed in fluid communication with the vessel outlet conduit 10 at the discharge side of the transfer pump 120. The vessel return conduit 129 may discharge into the corresponding first mixing compartment 174 or second mixing compartment 175 typically through the mixing vessel lid 5. Accordingly, in some applications, the vessel return conduit 129 may be used to selectively return the product mixture to the first mixing compartment 174 or second mixing compartment 175 for further mixing.

As illustrated in FIG. 4, at least one shear pump 182 may be disposed in fluid communication with each of the first mixing compartment 174 and the second mixing compartment 175. Accordingly, in some non-limiting applications, the components being mixed in the first mixing compartment 174 or the second mixing compartment 175 can be routed through the shear pump 182 for shearing of the components into smaller elements, as is known hy those skilled in the art, and the sheared components then returned to the first mixing compartment 174 or second mixing compartment 175 for further mixing.

Referring next to FIGS. 1-7 of the drawings, in some applications, some or all of the well materials 46 (FIG. 4) may be obtained from one or more material-containing sacks 44 (FIGS. 8-12). Accordingly, the system 1 may include at least one automatic sack cutting machine (ASCM) 12. As illustrated in FIGS. 1 and 2, the ASCM 12 may be supported by the rig deck 61 of the rig platform 60. In some embodiments, the ASCM 12 may have a design which is the same as or similar to that disclosed in U.S. Pat. No. 9,174,755, which is hereby incorporated by reference herein in its entirety. A non-limiting example of an ASCM 12 which is suitable for the purpose is the PROCUT™ Sack Cutting Unit which can be obtained from National Oilwell Varco (www.nov.com). ASCM 12 may run continually and perform the slitting, emptying and feeding sequence, including packing the emptied sack into a waste bag. The ASCM 12 may be capable of cutting and emptying different types of material-containing sacks 44 with well materials 46 such as mud additive chemicals, for example and without limitation. The ASCM 12 may provide a healthy and ergonomically correct workplace for an operator 68 (FIG. 2). The ASCM 12 may be capable of slitting the material-containing sack 44, separating the well material contents from the sack, packing the empty sack into a waste bag (not illustrated) and feeding the well material contents at the desired rate into the drilling fluid as the fluid is inixed in the mixing vessel 2.

As illustrated in FIGS. 1 and 2, in some applications, the ASCM 12 may be supported on the rig deck 61 of the rig platform 60. An ASCM support frame 70 may support the ASCM 12 on the rig deck 61. As illustrated in FIG. 1, in some applications, the ASCM support frame 70 may include an access scaffold 72 which provides the operator 68 (FIG. 2.) access to the ASCM 12.

A sack lifting platform assembly 74 may extend from the ground to the ASCM 12. The sack lifting plattbrm assembly 74 may include a lift platform 75. In some embodiments, the lift platform 75 may be electro-hydraulically operated and may be capable of elevating one or more of the material-containing sacks 44 to the ASCM 12. The operator 68 may slide the material-containing sack 44 from the lift platform 75 to the ASCM 12 for operation.

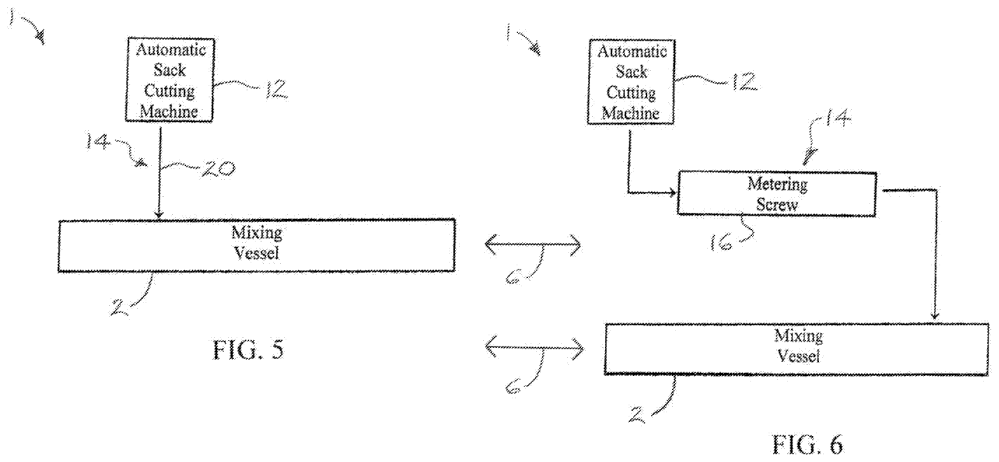

As illustrated FIGS. 5-7, in some embodiments, the mixing vessel 2 may be disposed along a horizontal axis 6 beneath the ASCM 12. At least one material transfer path 14 may extend from the ASCM 12 directly to the mixing vessel 2. In some embodiments, the material transfer path 14 may include at least one uninclined material transfer path and may be oriented at an angle of between 0 degrees and 90 degrees downwardly with respect to the horizontal axis 6. The material transfer path 14 may have a length or distance of 8 feet or less. In some embodiments, the material transfer path 14 may be a dedicated material transfer path for the transfer of well materials 46 from the ASCM 12 directly into the mixing vessel 2.

As illustrated in FIG. 5, in some embodiments, the material transfer path 14 may include at least one gravity flow conduit 20. The gravity flow conduit 20 may include a pipe, housing or other space which facilitates gravity flow of the well material from the ASCM 12 directly into the mixing vessel 2.

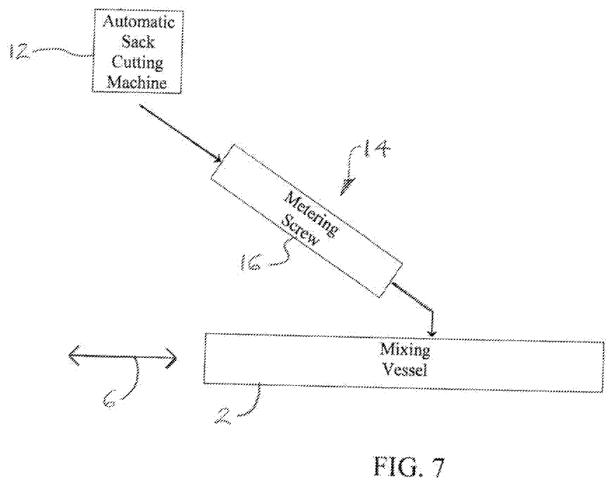

As illustrated in FIG. 6, in some embodiments the material transfer path 14 may include at least one horizontal metering screw 16 which transfers the well material from the ASCM 12 directly to the mixing vessel 2. The metering screw 16 may include at least one pipe or other conduit or housing (not illustrated) which contains an auger engaged for rotation by an auger motor (not illustrated). Accordingly, the auger may transfer the well material from the ASCM 12 through the housing directly into the mixing vessel 2 responsive to operation of the auger motor. As illustrated in FIG. 7, in still other embodiments, the material transfer path 14 may include at least one metering screw 14 which is oriented at a downward slope or angle from the ASCM 12 directly to the mixing vessel 2.

Referring again to FIGS. 1-3 of the drawings, in typical application of the system 1, the mixing vessel 2 can be used to simultaneously implement multiple operations in a hydrocarbon well drilling completion, production, maintenance and/or remediation project. The mixing vessel 2 may be capable of mixing single batch compounds or multiple compounds. For example and without limitation, the mixing vessel 2 can be used to simultaneously implement two or more of the following operations: mixing of drilling fluids, mixing of cement and cement spacers, mixing and filtering of completion brine and handling cuttings for zero-discharge applications. In some applications, multiple mixing and/or material handling operations can be simultaneously carried out in multiple mixing compartments (not illustrated) in the mixing vessel 2 without cross-contamination of the compound mixtures. All of the operations which are required throughout the hydrocarbon well drilling and completion project can be simultaneously or successively carried out in the mixing vessel 2.

Throughout the project, well materials 46 may be distributed from the large bags 64, rig bulk system 78, active mud lines 80 and/or auxiliary hopper 81 into the mixing vessel 2 typically through the respective vessel inlet conduits 8. Liquid additives 79 may be introduced into the mixing vessel 2 typically through the corresponding vessel inlet conduit 8. The well materials 46 may be used to form drilling mud or fluid in the active pit 82 and/or downhole mud pit 84 for the drilling operation and/or cement for the casing 97, centralizers and the like in the hydrocarbon well 88 using the cementing unit 83.

Referring next to FIGS. 8-12 of the drawings, a typical sequential application of the system 1 is illustrated. In FIG. 8, at least one material-containing sack 44 may initially be placed on the lift platform 75 of the sack lifting platform assembly 74. In some applications, the material-containing sack 44 may contain at least one well material used in the formulation of drilling mud or fluid and/or cement.

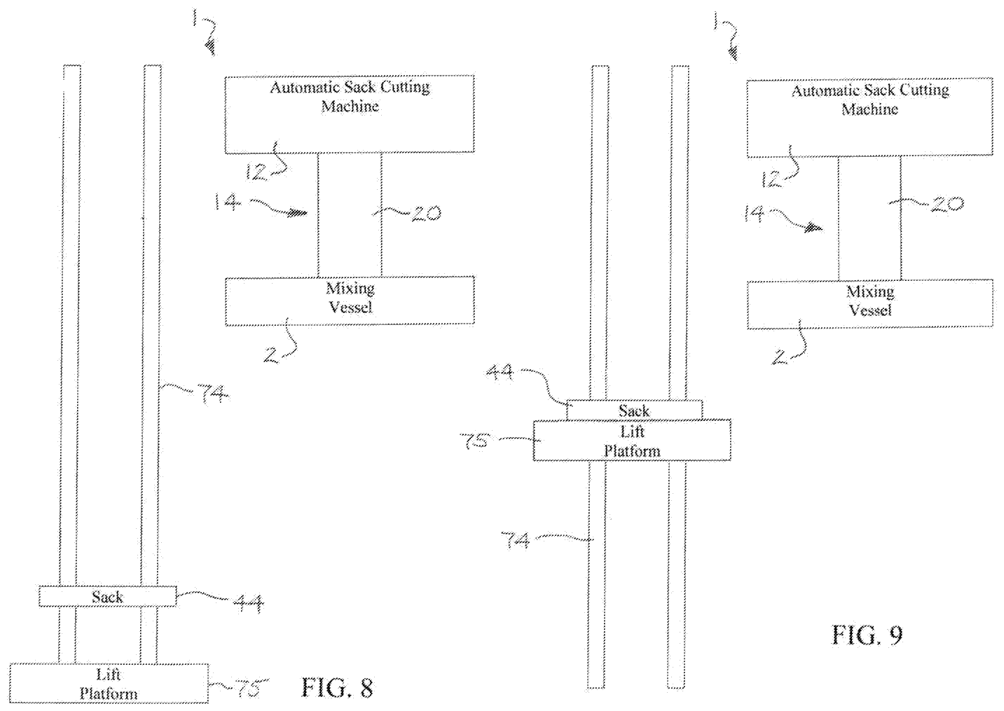

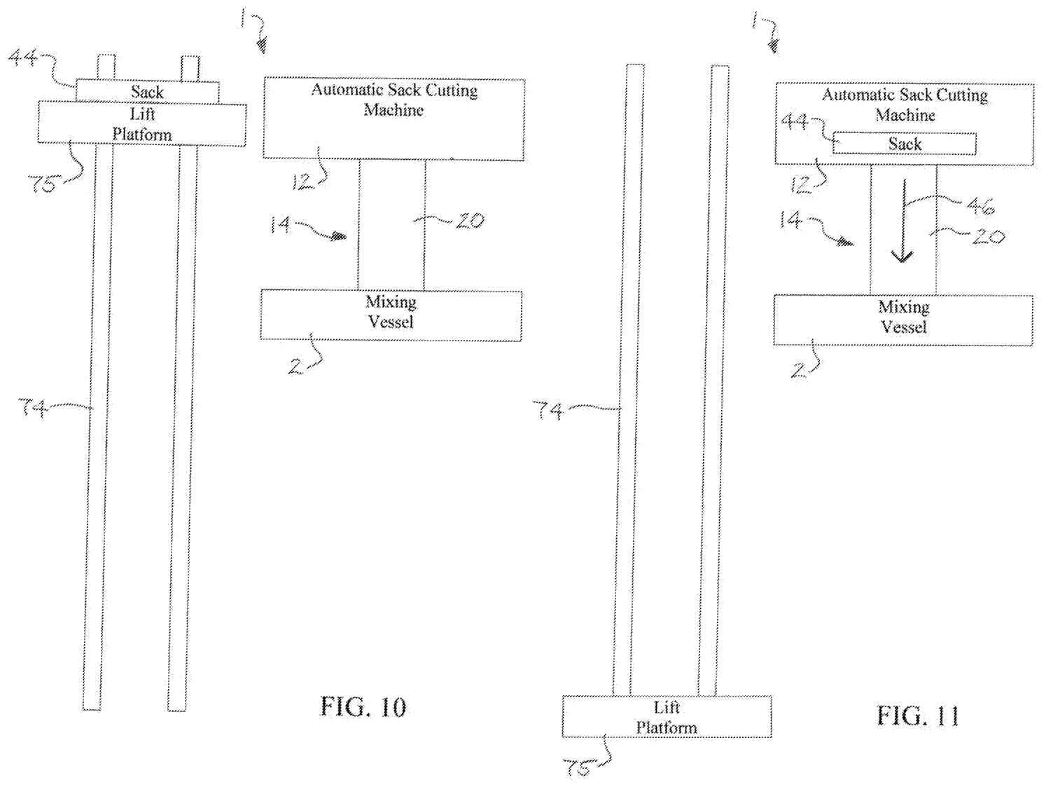

In FIGS. 9 and 10, the lift platform 75 of the sack lifting platform assembly 74 may lift the material-containing sack 44 to the level of the ASCM 12.

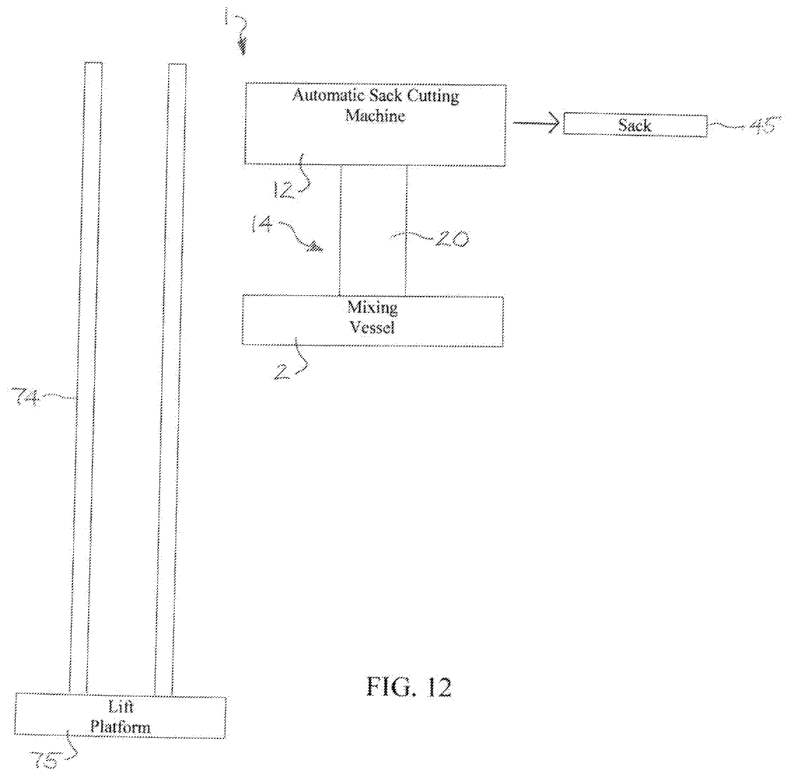

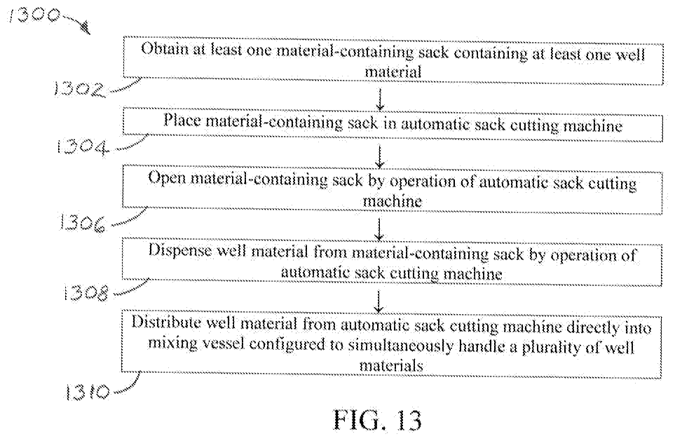

As illustrated in FIG. 11, the well-containing sack 44 may be removed from the lift platform 75 and placed in the ASCM 12. The ASCM 12 may automatically cut, open and remove the well materials 46 from the well-containing sack 44. The ASCM 12 may further discharge the removed well materials 46 directly into the mixing vessel 2 along the material transfer path 14. As illustrated in FIG. 12, the ASCM 12 may discharge the empty material-containing sack 45 into a semi-compactor or other suitable waste receptacle (not illustinted).

Referring next to FIG. 13 of the drawings, a flow diagram 1300 of an illustrative embodiment of the well material distribution methods is illustrated. At Step 1302, at least one material-containing sack containing at least one well material may be obtained. At Step 1304, the material-containing sack may be placed in an automatic sack cutting machine (ASCM). At Step 1306, the material-containing sack may be opened by operation of the ASCM. At Step 1308, the well material may be dispensed from the material-containing sack by operation of the ASCM. At Step 1310, the well material may be distributed from the ASCM directly into a mixing vessel configured to simultaneously handle a plurality of well materials.

While certain illustrative embodiments of the disclosure have been described above, it will be recognized and understood that various modifications can be made to the embodiments and the appended claims are intended to cover all such modifications which may fall within the spirit and scope of the disclosure.

1. A well material distribution system, comprising:
an automatic sack cutting machine configured to open at least one material-containing sack and dispense at least one well material from the at least one material-containing sack; and
at least one mixing vessel disposed in direct communication with the automatic sack cutting machine, the at least one mixing vessel configured to simultaneously handle a plurality of well materials and receive the at least one well material directly from the automatic sack cutting machine.

2. The well material distribution system of claim 1 wherein the at least one mixing vessel is disposed within a plane beneath the automatic sack cutting machine, and further comprising at least one gravity flow conduit directly connecting the at least one mixing vessel to the automatic sack cutting machine along an uninclined material transfer path.

3. The well material distribution system of claim 1 further comprising at least one metering screw connecting the at least one mixing vessel directly to the automatic sack cutting machine along an uninclined material transfer path.

4. The well material distribution system of claim 3 wherein the at least one metering screw is disposed at a downward angle from the automatic sack cutting machine to the at least one mixing vessel.
